(19) United States
(12) Patent Application Publication
(10) Pub. No.: US 2010/0046820 A1
(43) Pub. Date: Feb. 25, 2010

(54) FRAMING OF POSITRON EMISSION TOMOGRAPHY DATA TO ASSESS ACTIVITY PEAK

(76) Inventors: Jerome Declerck, Oxford (GB); David Schottlander, Sutton Courtenay (GB)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/507,156

(22) Filed: Jul. 22, 2009

(30) Foreign Application Priority Data
Jul. 22, 2008 (GB) 0813368.8
Jul. 20, 2009 (GB) 0912491.8

(51) Int. Cl. G06K 9/00

(52) U.S. Cl. 382/131; 382/284

(57) ABSTRACT

In a method and apparatus for determining a framing interval used when reconstructing medical scanning data such as Positron Emission Tomography (PET) scans, peak activity in the Blood Input Function Time Activity Curve is identified by regions of maximum rate of change and the framing interval is selected to include the peak in a frame. Once the framing interval is established, reconstruction of the data is performed by conventional methods.

### BACKGROUND OF THE INVENTION

1. Field of the Invention

The present invention is concerned with optimizing the reconstruction of Positron Emission Tomography (PET) data in order to derive quantitative measures of blood flow.

2. Description of the Prior Art

Dynamic PET imaging is used to derive quantitative measures of myocardial blood flow in the left ventricle of the heart. Such dynamic imaging is performed using a radiotracer Rb82 or 13N-ammonia. PET data is acquired over a period of time and is then divided into ‘frames’ which comprise individual 3-D datasets that span the time period of the scan. The dynamic frames are formed by reconstructing the continuously acquired PET data at time intervals manually selected by the user, however the user has no practical way of determining precisely when the peak uptake will occur and has to rely upon a rule of thumb. For example a scan lasting 5 minutes may be split into a series of frames lasting 5 secs, 5 secs, 5 secs, 5 secs, 5 secs, 5 secs, 10 secs, 10 secs, 10 secs, 20 secs, 20 secs, 20 secs, 30 secs, 60 secs, 90 secs. From these frames, regions of interest in the myocardium can be found on consecutive frames and their activity plotted over time. This is a Time Activity Curve (TAC). Such a TAC is illustrated in FIG. 1.

In assessing the data a kinetic model is used in order to assess the flow in the myocardium. In order to do this it is also necessary to assess the Blood Input Function (BIF) which is the flow into the blood pool in the left ventricle. For accurate analysis it is crucial that the peak activity is found accurately and therefore it is required that this peak is in the middle of one of the short dynamic time frames near the start of the acquisition. (FIG. 2). If the peak were not captured in this way then the frame would be subject to partial volume effects meaning that the peak activity is not well captured.

FIG. 3ashows an actual BIF TAC and FIGS. 3b and 3c shows the effect if different framing intervals on sampling.

To date, the matter of framing interval selection has often depended on the experience of the clinician, who will often frame all the data in the same way, irrespective of the patient. If the peak is missed, it will not be apparent to the clinician or reader of the data and it could lead to errors in downstream computation that relies on the correct detection of the peak in the blood input function, i.e. the kinetic model analysis which is used to find the myocardial flow statistics.

Another method of providing the framing involves using the list-mode data and placing a framing interval every n counts. This provides a uniform quality framing but still does not guarantee achieving the peak.

There remains a requirement for a reliable method of determining the peak of the BIF in order to facilitate a good framing estimate to ensure that the time of the peak uptake corresponds to a PET volume frame in the reconstruction.

### SUMMARY OF THE INVENTION

in accordance with the present invention, in a method and an apparatus for determining a framing interval, used when reconstructing medical scanning data such as Positron Emission Tomography (PET) scans, peak activity in the Blood Input Function (BIF) Time Activity Curve (TAC) is identified by regions of maximum rate of change, and the framing interval is selected to include the peak in a frame. Once the framing interval is established, reconstruction of the data is performed by conventional methods.

Preferably a complete field of view is selected for deriving a time activity curve.

The invention allows any sharp change in the PET tracer activity to be detected and frames selected accordingly.

### BRIEF DESCRIPTION OF THE DRAWINGS

FIG. 1 shows a three time activity curves for the left ventricle region of the heart.

FIG. 2 shows a typical BIF TAC that is acquired from sample frames.

FIGS. 3a-3c show the effects, including partial volume effect, of different sampling frames on the observed TAC.

FIG. 4 illustrates how the field of view associated with the dataset can be used to generate a time activity curve if the field of view is small.

FIG. 5 illustrates the concept of Parzen Windows.

FIG. 6 illustrates shows an example of how a peak activity frame is defined.

FIG. 7 illustrates an example of apparatus that may be used to work the method of the invention.

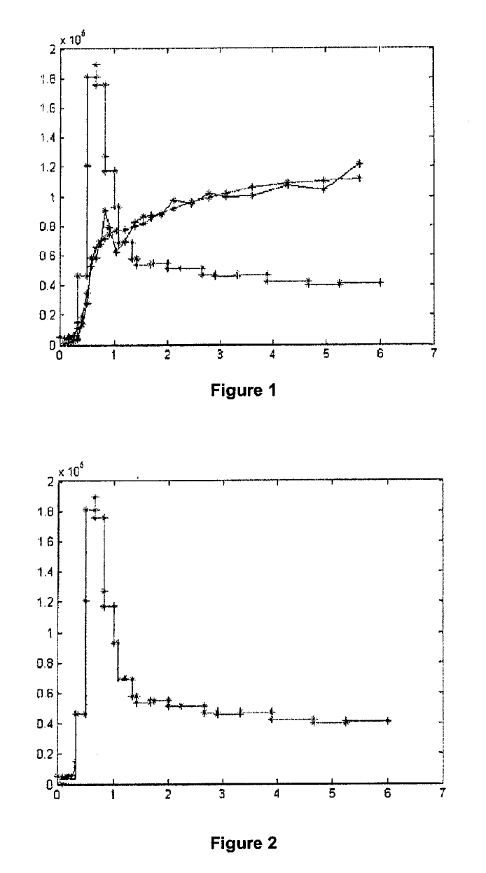

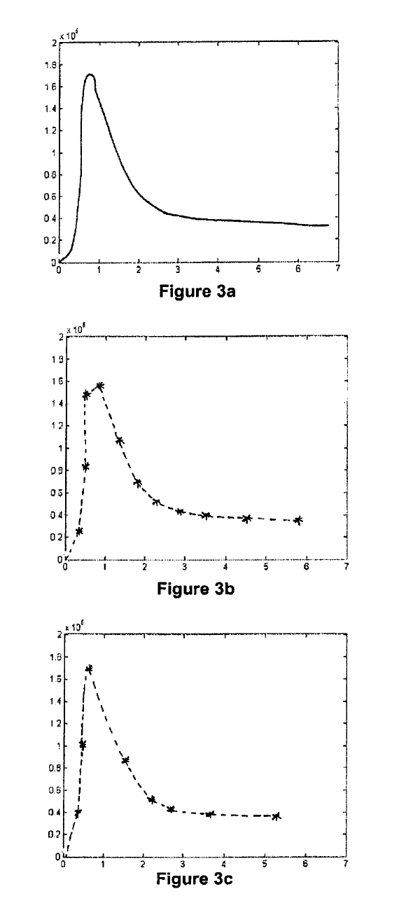

### DESCRIPTION OF THE PREFERRED EMBODIMENTS

The present invention is based on a method and apparatus for identifying sharp changes in curvature of a BIF TAC, in order to facilitate the selection of optimal framing. Once the framing is determined, PET reconstruction proceeds conventionally using any standard reconstruction algorithm.

There are two main steps to the method:

1. determining a representative TAC of tracer from the measured PET data from which to decide the correct framing.

2. deciding the correct framing, given a TAC.

### 1. Finding a Representative Curve:

There are two methods that can be used to find an estimate of the BIF TAC in order to estimate its peak:

METHOD I: The first method of finding the curve uses the raw list-mode data derived from the PET acquisition.

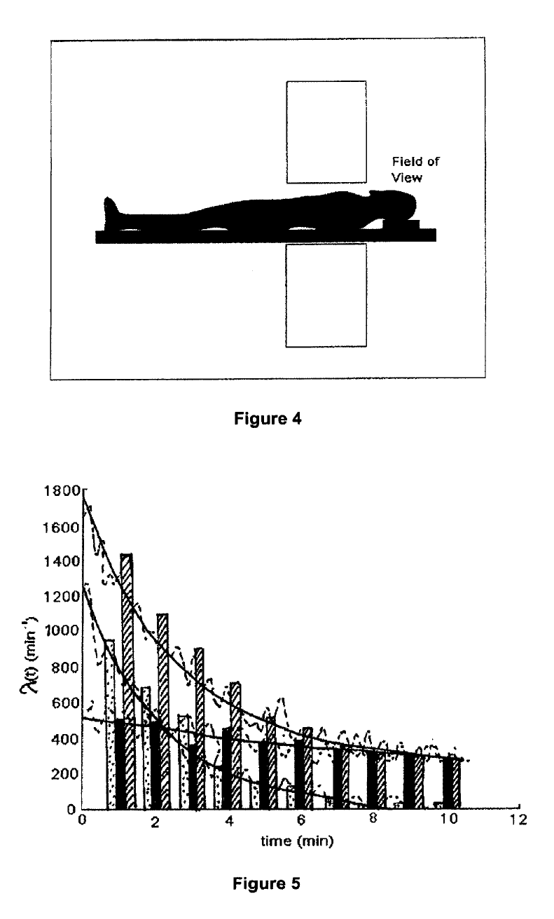

It should be noted that this approach is applicable to scenarios in which the portion of the body of interest is within the scanner field of view (FOV) and the rest of the body is outside of the FOV (typical of human scans, FIG. 4).

The entire set of measured PET data can be used to form a single TAC, known as a head curve. That is all the counts over the volume that is scanned are used to find a single TAC. This is typically achieved using the Parzen Window technique, in which a Gaussian curve is placed on the X-axis of a 2D plot, representing each time of arrival of list-mode events. The sum of all the Gaussian's provides a curve that is representative of the total time activity curve in the acquisition and within the scanner FOV.

FIG. 5 illustrates the concept of Parzen windows. Three representative sets of list-mode data are shown. In each case, the solid curve shows the idealized rate function, the bars shows the histogram version of the data (i.e. the sinogram data) and the dashed ‘noisy’ curve shows the results of applying a Parzen window to the set of list-mode data. In this example, all the curves are representative of a simple exponentially decaying set of data, representative of a phantom of activity.

METHOD II: The second method is applicable to cases where the entire subject is contained within the FOV of the scanner, in which case the head curve would be nearly pure exponential (due to activity decay), since all activity in the body would be visible in the scanner at all time frames. An example of this scenario is mouse imaging in a long bore scanner. In that case, the method entails several steps:

1. Divide the volume to be reconstructed into a very coarse 3 dimensional grid (e.g. 50 mm×50 mm×50 mm), ensuring that the individual mesh elements are large enough to contain the objects of interest, for example, the myocardium or the aortic arch.

2. Reconstruct each of the coarse grid elements using a temporal reconstruction scheme directly from list-mode data (Nichols, Jinyi-Qi et al. 2002; Schottlander, Louis et al. 2006). The output of the reconstruction scheme is a temporal function for each course voxel, which, in effect, provides a head curve for each of the coarse voxels.

3. Choose the curve from the grid element that represents the region for which the time of the peak in the curve is required

### 2. Determining the Peak of the Activity:

Having determined an estimate of the BIF TAC, the TAC should be analyzed in order to find the feature of interest. In the case of myocardial assessment the peak can be found by either taking the maxima of the curve or the point of greatest curvature.

Local maxima are found by identifying the points of the curve where the rate of change (first derivative) is zero and the second derivative is negative. Alternatively features that correspond to the point of maximum curvature can be found. Curvature of a parametric curve y=f(x) (where in this case x corresponds to time, and y is the activity) is defined as

Kappa=|y″|/(1+y′²)^{3/2}

Where y′ is the first derivative of f(x), y″ is the second derivative of f(x).

In other types of scans different features may be required to determine the framing.

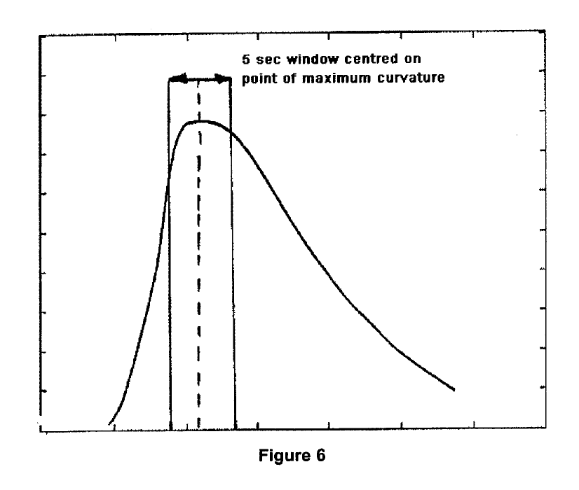

This feature of interest can then be used to determine the framing intervals, by ensuring that the feature of interest is at the centre of a short dynamic frame. In the case of the myocardial flow a 5 second frame would be used with the peak at its center and the other frames defined around this (FIG. 6).

It should be noted that the concept can be extended such that, given a known framing (determined by the user), the list-mode data can be inspected and a quality control measure calculated based on the number of counts in the frame and the expected variance given that number of counts.

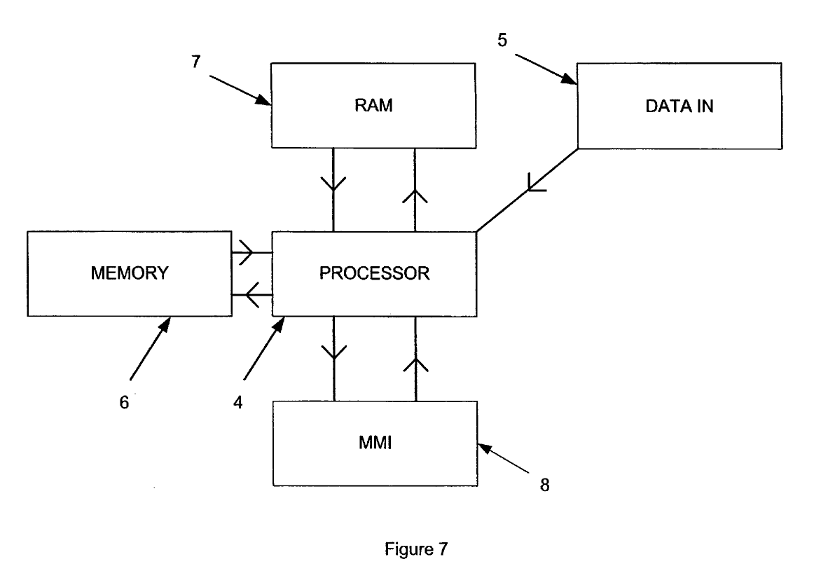

Referring to FIG. 7, the invention may be conveniently realized as a computer system suitably programmed with instructions for carrying out the steps of the method according to the invention.

For example, a central processing unit 1 is able to receive data representative of medical scans via a port 2 which could be a reader for portable data storage media (e.g. CD-ROM); a direct link with apparatus such as a medical scanner (not shown) or a connection to a network.

Software applications loaded on memory 3 are executed to process the image data in random access memory 4.

A Man—Machine interface 5 typically includes a keyboard/mouse/screen combination (which allows user input such as initiation of applications and a screen on which the results of executing the applications are displayed.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method of processing a digital signal from medical data acquisition a scanner comprising the steps of
selecting at least one region of A Field of View (FOV) of the scanner;
deriving a Time Activity Curve (TAC) for the region of the FOV;
identifying at least one region in the TAC corresponding to maxima, or points of maximal curvature;
selecting framing intervals such that the identified regions of the TAC lie within single intervals; and
reconstructing the signal to form an image associated with each time interval.

2. A method according to claim 1, wherein an entirety of the FOV is selected for deriving a time-activity curve.

3. An apparatus for processing a digital signal from a medical data acquisition scanner comprising:
a selection unit configured to select at least one region of a Field of View (FOV) of the scanner;
a processor that derives a Time Activity Curve (TAC) for the region of the FOV;
said processor being configured to identify at least one region of the TAC corresponding to maxima, or points of maximal curvature;
said processor being configured to select framing intervals such that the identified regions of the TAC lie within single intervals; and
a computer that reconstructs the signal to form an image associated with each time interval.
